(19) United States
(12) Patent Application Publication
(10) Pub. No.: US 2021/0107009 A1
(43) Pub. Date: Apr. 15, 2021

(54) INTERLACED WIRE CLAMPS FOR LABORATORY SHAKERS

(71) Applicant: LabStrong Corp., Dubuque, IA (US)

(72) Inventor: Mark David Lockwood, Dubuque, IA (US)

(73) Assignee: LabStrong Corp., Dubuque, IA (US)

(21) Appl. No.: 17/047,926

(22) PCT Filed: Apr. 16, 2019
(86) PCT No.: PCT/US2019/027608

§ 371 Date: Oct. 15, 2020

Related U.S. Application Data
(60) Provisional application No. 62/658,225, filed on Apr. 16, 2018.

(51) Int. Cl. B01L 9/00; F16B 5/07

(52) U.S. Cl. CPC B01L 9/50; F16B 2001/0035; B01L 2200/025; F16B 5/07

(57) ABSTRACT

Disclosed herein are flask clamps that capture and firmly hold flasks or vessels of various shapes, enclosing the sidewall of the flask or vessel in a trap or loops. The trap relatively conforms to the profile of the perimeter of the vessel and are spring loaded in the upward direction in order to rise upward along the sides of the vessel. The loops pivot relative to the bottom of the flask creating an arc motion that tightens against the sidewall as it rises. The loaded loops are in tension against the flask, and the multiplicity of loops hold vessels in tension with opposing forces.

### CROSS-REFERENCE TO RELATED APPLICATIONS

This application claims benefit of priority to U.S. Provisional Application Ser. No. 62/658,225, filed Apr. 16, 2015, the contents of which are incorporated by reference in its entirety.

### FIELD OF INVENTION

The invention pertains to laboratory products and in particular to clamps for laboratory shakers.

### BACKGROUND

Shakers are widely used in laboratories to stir liquids held in beakers, flasks or test tubes. The shaker has a platform that oscillates horizontally when the shaker is operating. A shaker platform will normally include an array of threaded holes to enable attachment of clamps to the platform with threaded fasteners such as screws or bolts. Metal flask clamps for Erlenmeyer flasks typically include a pair of intersecting bands that extend horizontally to form a base and bend upward to extend above the hip of the flask and along the tapered wall of the flask. Normally, a spring coil is attached around the ends of the bent bands. The flask is inserted into the clamp by expanding the spring coil and the bands outwardly by pressing the base of the flask into the opening created by the spring coil. One of the issues with metal clamps of that flasks tend to spin within the clamps when the shaker operates. The spinning can cause marring if the flask is made of glass, and in fact can cause substantial damage if the flask is made of plastic. Another issue is that metal springs require extreme forces to insert or remove the flask, and there is the danger of flask breakage. In addition, the metal springs tend to deform and loosen after repeated use and the flasks tend to rattle loosely inside the metal flask clamp creating significant noise pollution in the workspace. If the flask contains a large volume of fluid significant torque is generated which can cause the flask to spin excessively within the clamp especially if the metal springs are loose. As a result, there is a need for improved flask clamps for laboratory shakers.

### BRIEF SUMMARY OF THE INVENTION

Disclosed herein are flask clamps that capture and firmly hold flasks or vessels of various shapes, enclosing the sidewall of the flask or vessel in a trap or loops. The trap relatively conforms to the profile of the perimeter of the vessel and are spring loaded in the upward direction in order to rise upward along the sides of the vessel. The loops pivot relative to the bottom of the flask creating an arc motion that tightens against the sidewall as it rises. The loaded loops are in tension against the flask, and the multiplicity of loops hold vessels in tension with opposing forces.

The clamp comprises a base and a multiplicity of interlaced loops. Each of the interlaced loops comprise a first end, a second end, and a curved member between the first end and the second end. The multiplicity of interlaced loops are pivotally connected by the first end and the second end to the periphery of the base, the curved members are configured to spontaneously coalesce, and interlaced loops are configured for concerted movement when an effective opening force is applied to any curved member.

In one embodiment, the base comprises a multiplicity of socket pairs comprising a first socket and a second socket. The multiplicity of socket pairs is equal to the multiplicity of interlaced loops, and the first socket and the second socket of a single socket pair are configured to receive the first end and the second end of a single interlaced loop. In certain embodiments, the first and second socket are axially offset from one another. When the first and second ends are placed into the offset axially-parallel sockets, the interference loads the wire to move in an upward direction to a neutral load position.

In another embodiment, the multiplicity of interlaced loops are pivotally connected to the base via a multiplicity of torsion spring pairs comprising a first torsion spring formed from or connected to the first end of a single interlaced loop and a second torsion spring formed from or connected to the second end of the single interlaced loop, and the multiplicity of torsion spring pairs is equal to the multiplicity of interlaced loops.

The interlaced loops may further comprise a catch configured to engage another of the loops when each of the multiplicity of interlaced loops are in a coalesced state, forming an opening for receiving a flask. In certain embodiments, the catch comprises a sigmoidal turn within the curved member.

In some embodiments, the clamp comprises two, three or four interlaced loops. In a particular arrangement, a first wire loop is arranged over a second wire loop and under a third loop; the second wire loop is arranged over the third wire loop and under the first loop; and the third loop is arranged over the first loop and under the second loop. The first loop may comprise a catch configured to engage the second loop; the second loop may comprise a catch configured to engage the third loop; and the third loop may comprise a catch configured to engage the first loop.

In some embodiments, the clamp is configured to receive an Erlenmeyer flask, a Florence flask, a round-bottom flask, or a cylindrical beaker.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates an exemplary embodiment of the invention holding an Erlenmeyer flask on a stage.

FIGS. 2A-2C illustrates an exemplary embodiment of the invention from a first view (FIG. 2A), a second view (FIG. 2B), and a third view (FIG. 2C).

FIG. 3 illustrates a loop of FIG. 2A.

FIG. 4 illustrates an exemplary embodiment of the invention from a first view.

FIG. 5 illustrates a loop of FIG. 4.

FIG. 6 illustrates an exemplary embodiment of the invention from a first view.

FIG. 7 illustrates a loop of FIG. 6.

FIG. 8 illustrates an exemplary embodiment of the invention from a first view.

### DETAILED DESCRIPTION OF THE INVENTION

Disclosed herein are flask clamps that capture and firmly hold flasks or vessels of various shapes, enclosing the sidewall of the flask or vessel in a trap or loops. The trap relatively conforms to the profile of the perimeter of the vessel and are loaded in order to rise along the sides of the vessel. The loops pivot relative to the bottom of the flask creating an arc motion that tightens against the flask's sidewall. The loaded loops are in tension against the flask, and the multiplicity of loops hold vessels in tension with opposing forces.

There are a number of advantages that may be realized by using the clasps as described herein. These clamps may be used with thin-walled and/or plastic flasks susceptible to crushing by the clamps known in the art since the compressive force applied by the loops onto the side wall is distributed around a majority of the periphery. The clamps continuously self-tighten with any flask movement away from center. The clamps allow for quiet operation and minimize marring of the sidewall surface because rattling of the flask is minimized or eliminated entirely. The clamps also allow for flask size variance such as texture, diameter, height, and pitch. The force applied to any one loop is transferred to all of the loops, allowing for easy insertion or removal of the vessel. The profile of the loops may be thin to provide for minimally obstructed viewing of the contents within the flask. Moreover, the clamp may be constructed without sharp edges of sheet metal profiles that can cut or abrade personal protective equipment, such as gloves, or the user's skin.

The flask clamp includes a flask holding mechanism attached to the clamp base. The flask holding mechanism comprises a multiplicity of interlaced loops. Each of the loops comprise a first end, a second end, and a curved member between the first and second ends. In the exemplary embodiments illustrated below, the loops have a D-like profile, but other profiles may be used however. The loops may optionally comprise contoured rollers attached to the curved members. The wire loops may be pivotally connected to the periphery of the base.

Because the loops are interlaced, some of the advantages described above are realized. The loops may spontaneously coalesce. As used herein, “spontaneously coalesce” means that the curved member of each loop is capable of moving away from the base and inwardly toward an imaginary line normal to the center of the base after an effective opening force is removed from the curved member without apparent external influence, force, or cause due to the loading on the loops. Because the loops are interlaced, they can coalesce and form an opening for receiving the flask. The loops may also comprise a catch for engaging another loop, resulting in a coalesced state and forming an opening of a designed size for receiving a flask. As used herein, a “coalesced state” means the opening formed from the loops is minimized. In some cases, the catch is a sigmoidal turn in the curved member.

The loops may be interlaced in an over-under arrangement. For a flask having three loops, the underside of a catch on a first loop engages an adjacent second loop, the underside of a catch on the second loop engages a third loop, and the underside of a catch on the third loop engages the first loop. Although the immediately prior example illustrates the over-under arrangement with three loops, the clamp may have any suitable number of loops. Suitably, the clamp may be formed from 2 loops, 3 loops, 4 loops, 5 loops, 6 loops, or more than 6 loops. Embodiments having 4, 5 or 6 loops of wire offer redundant strength to eliminate single fault failure and loss of flask containment or may be more suitable for larger flasks.

A force applied to one of the loops will be transferred to all of the other loops. Interlacing the loops results in concerted movement between the loops. This advantageously allows for a flask to be easily inserted into or removed from the clamp. An effective opening force applied to any one curved member in the direction of the base will cause the opening formed by the curved members to widen, allowing for the flask to be inserted. As used herein, an “effective opening force” is a force sufficient to increase the size of the opening relative to the size of the opening in a coalesced state. Moreover, an effective opening force applied to any one curved member in the direction of the base will cause the opening formed by the curved members to widen, allowing for the flask to be removed from the clamp.

The clamp may have a generally circular base and the loops may be evenly spaced around the periphery. The loops may be connected to the base in any suitable manner that results in loading the holding forces. Loading may be affected by the positioning of the curved members, the form for the curved members, the mechanical properties of the curved members, or any combination thereof.

In some embodiments, the base comprises a multiplicity of socket pairs. Each of the socket pairs comprises a first and a second socket. The number of socket pairs may be equal to the number of loops so as to receive the first and second end of a loop in the first and second socket. In certain embodiments, the first and second socket are axially offset from one another and arranged along the periphery of the base. Because the sockets are axially offset, a suitably conformed loop with result in spring-like loading. The offset sockets create a torsion effect on the spring wires, clamping onto the flask, and allow for the benefits described herein.

In another embodiment, the loops may be connected to the base via a multiplicity of torsion spring pairs. The torsion spring pairs comprise a first and a second torsion spring formed from or connected to the first and second end of the loop, respectively. The torsion springs load the loop and allow for the benefits described herein.

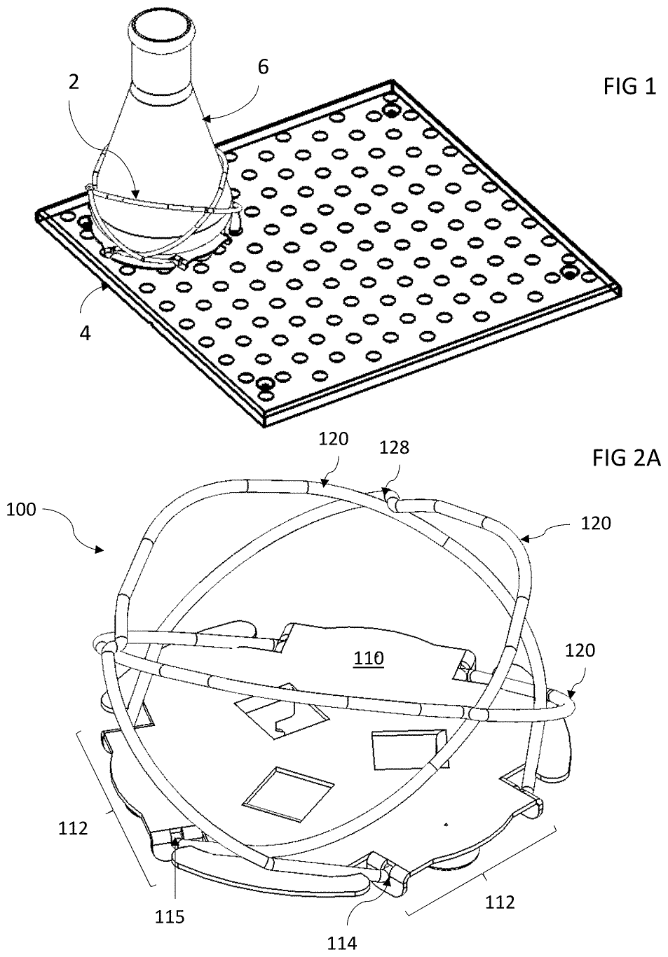

The clamps described herein may be used in variety of different settings. In one embodiment, the clamp is configured for use with a laboratory shaker. An exemplary embodiment is illustrate in FIG. 1. The clamp 2 may also be configured for use with a fixed stage or a movable stage 4 to prevent tipping of the flask 6 or spilling of the flask's contents during use, e.g., sampling from the flask, or transport, e.g., moving between work stations. The clamp may also be configured for use with automated or robotic laboratory equipment and processes.

The clamp base may include a removable, elastomeric cover that provides a frictional surface for the base of the flask. The frictional forces on bottom surface of the flask prevent the flask from spinning when the shaker is in use. The downward component of the normal force exerted on an Erlenmeyer flask by the clamp facilitates the effect of the frictional surface. The elastomeric cover also preferably includes an overlapping lip that extends over the peripheral edge of the base, and in some places underneath the base. The lip provides a seal against the shaker platform in case of a spill inasmuch as magnetic pressure pulls the base of the flask clamp and the elastomeric lips against the shaker platform. It has been found that the above described configuration including the elastomeric, replaceable cover and the contoured plastic rollers (or roller sets) provide a desired amount of cushioning and significantly quieter operation of the shaker.

One or more permanent magnets may be attached and exposed below the base, preferably three nickel-coated, rare earth magnets equally spaced around the periphery of the base. For stability purposes, it has been found desirable to equally space the magnets from one another and also locate the magnets near the periphery of the clamp base. Placing the magnets near the periphery of the clamp base maximizes flux density of the magnetic field near the periphery of the base, as opposed to using a single magnet centered under the flask.

The nickel-coated, rare earth magnets are preferably flat magnets, and the flat bottom surface of the magnets (as well as a magnetic base plate) are magnetically attracted to the shaker platform, which is preferably made of magnetic, non-magnetized stainless steel. The nickel coating helps to protect the rare earth magnets from corrosion and chipping and also provides an improved surface for adhesion of the magnets to the clamp base. In addition, the use of a nickel coating does not compromise the viability of biological cells in the laboratory, as would for example a zinc coating. The use of multiple rare earth magnets allows for the polar alignment of the magnets to be optimized in order to increase the magnetic flux density between the flask clamp base and the platform. For example, staggered polar alignment may increase magnetic flux density and overall attraction of the clamp to the shaker platform. The rare earth magnets are preferably adhered to the top base plate which is made of magnetic stainless steel. The use of the magnetic stainless steel top base plate reduces the magnetic field in the flask and additionally helps to focus magnetic flux density (magnetic attraction) between the base plate and the shaker platform. In an alternative embodiment, the rare earth magnets can be manufactured with a step peripheral shoulder, and instead of using adhesive to attach the magnets to the top base plate, the magnets are attached to the base by mechanically capturing the shoulders on the magnets between the plates in the base assembly.

The base of the flask clamp may also include downwardly extending positioning bosses, for example three or more positioning bosses may be made of the same material as the base of the clamp or made of an engineered thermal plastic such as polyoxymethylene. The downwardly extending bosses are sized and configured to fit into clamp positioning holes or indentations on the shaker platform when the flask clamp is positioned on the shaker platform with the magnets exerting magnetic pressure to hold the flask clamp on the shaker platform. The positioning bosses prevent the flask clamp from sliding on the surface of the shaker platform while the shaker is in use. The clamp positioning holes or indentations on the shaker platform are preferably non-threaded such that the positioning bosses can be easily set in the holes or indentations without a tool.

In some embodiments, the clamp base may be mechanically fastened to the shaker platform with one or more threaded fasteners such as screws, bolts, or other suitable fastening components.

The clamp base as described above can be used to hold other types of laboratory containers besides an Erlenmeyer flask, e.g., a Florence flask, a round-bottom flask, or a cylindrical beaker. Suitably the clamp may be configured to receive any flask or laboratory having a profile similar to any of the forgoing.

The clamp and its components may be prepared of any suitable material. Wire form loops may be preferred for certain applications due to its tensile strength and ability to be repeatedly autoclaved, but a similarly functioning assembly may be prepared in alternative materials, such as plastic that can be molded inexpensively. Those of skill in the art are capable of selecting materials for appropriate specialty applications.

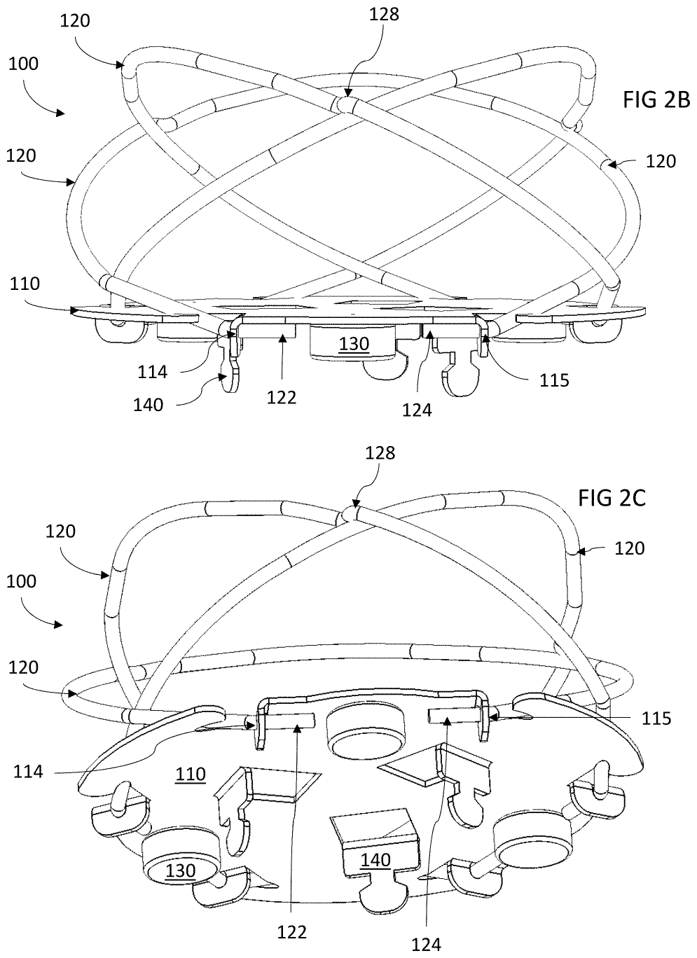

An exemplary embodiment of the invention is depicted in the Figures. FIG. 2A-2C illustrates a flask clamp 100 composed of three interlaced wire form loops 120 in an over-under arrangement pivotally connected to a base 110. A base 110 comprising three socket pairs 112 evenly spaced around the periphery of the base 110 is depicted The socket pair 112 comprises a first socket 114 and a second socket 115 configured to receive the first end 122 and the second end 124 of the wire form loop 120, respectively. When all of the loops 120 are so attached in an interlaced over-under arrangement, the loops 120 will spontaneously coalesce and the catch 128 of one loop 120 will engage a different loop, forming an opening for receiving a flask. FIG. 2A-2C also illustrate components for securing the clamp 100 to a stage, including magnets 130 and positioning bosses 140.

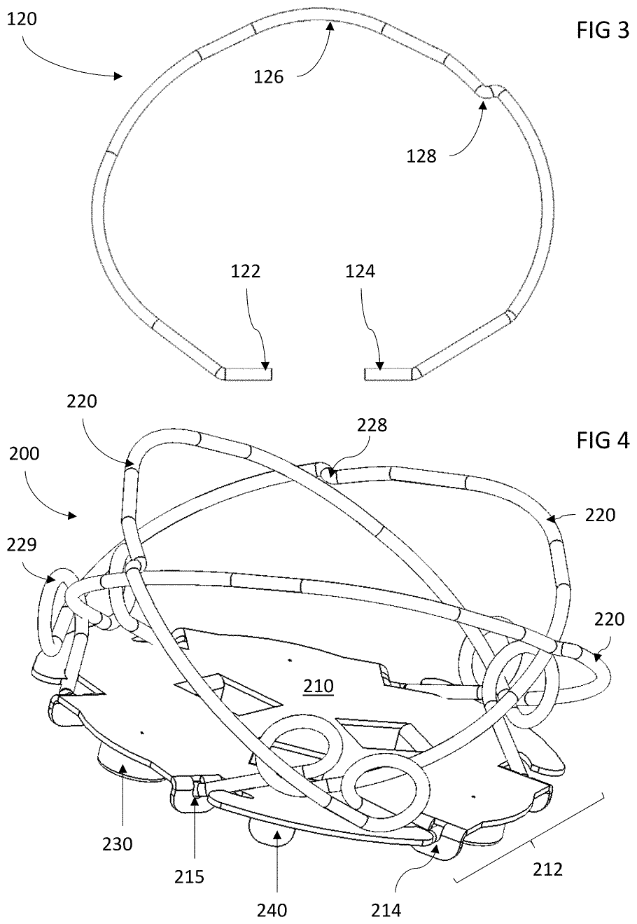

Referring now to FIG. 3, a wire form loop 120 in a D-like configuration is depicted. The loop 120 comprises a first end 122, a second end 124, and a curved member 126 therebetween. Also depicted is a catch 128 formed from a sigmodal turn in the wire form loop. The interlaced loop spontaneously coalesce and form an opening for receiving a flask. The positioning of the catches 128 on the loops determines the size of the opening and can be tailored to the size and/or shape of the flask. Thus the clamps described herein may be used to secure a variety of types of glassware.

FIG. 4 illustrates another embodiment of the invention wherein the interlaced loops comprise a coil loop. The clamp 200 is composed of three interlaced wire form loops 220 in an over-under arrangement pivotally connected to a base 210. The base 210 comprises three socket pairs 212 evenly spaced around the periphery of the base 210 The socket pair 212 comprises a first socket 214 and a second socket 215 configured to receive the first end and the second end of the wire form loop 220, respectively. When all of the loops 220 are so attached in an interlaced over-under arrangement, the loops 220 will spontaneously coalesce and the catch 228 of one loop 320 will engage a different loop, forming an opening for receiving a flask. FIG. 4 also illustrates components for securing the clamp 200 to a stage, including magnets 230 and positioning bosses 240.

Referring now to FIG. 5, a wire form loop 220 in a D-like configuration is depicted. The loop 220 comprises a first end 222, a second end 224, and a curved member 226 therebetween. Also depicted is a catch 228 formed from a sigmodal turn in the wire form loop and coil loops 229. The interlaced loops interact through 228 so that when one is compressed towards the base, all loops move in a similar fashion. Although FIG. 5 illustrates that the coil loops 229 comprise a single coil loop, those of skill in the art may prepare coil loops having more than one coil loop. Suitably each coil loop may be comprises to two, three, four, five, size, or more than six coil loops. The coil loops 229 may contribute to the loops ability to spontaneously coalesce. Suitably, the coil loops may act as torsion springs. The interlaced loops spontaneously coalesce and form an opening for receiving a flask. The positioning of the catches 228 on the loops determines the size of the opening and can be tailored to the size and/or shape of the flask. Thus the clamps described herein may be used to secure a variety of types of glassware.

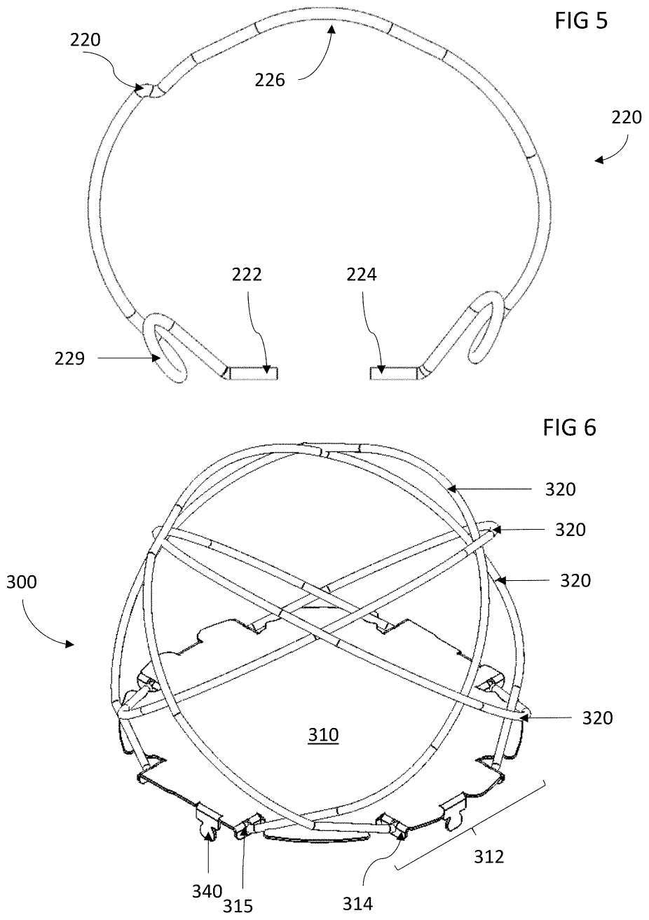

FIG. 6 illustrates another embodiment of the invention comprising four interlaced loops. Such a clamp may be well suited for larger flaskware such as 1000 mL, 2000 mL, or larger flasks. The clamp 300 is composed of four interlaced wire form loops 320 in an over-under arrangement pivotally connected to a base 310. The base 310 comprises three socket pairs 312 evenly spaced around the periphery of the base 310 The socket pair 312 comprises a first socket 314 and a second socket 315 configured to receive the first end and the second end of the wire form loop 320, respectively. When all of the loops 320 are so attached in an interlaced over-under arrangement, the loops 320 will spontaneously coalesce forming an opening for receiving a flask. FIG. 6 also illustrates components for securing the clamp 300 to a stage, including positioning bosses 340.

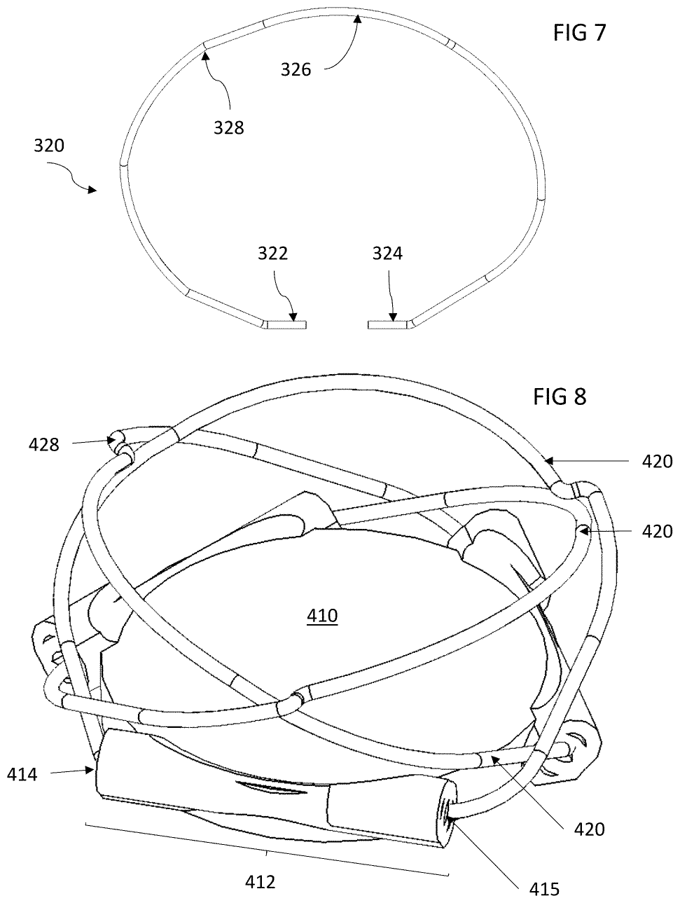

Referring now to FIG. 7, a wire form loop 320 in a D-like configuration is depicted. The loop 320 comprises a first end 322, a second end 324, and a curved member 326 therebetween. Also depicted is a catch 328 formed from a positioned turn in the wire form loop. The interlaced loops spontaneously coalesce and form an opening for receiving a flask. The positioning of the catches 328 on the loops determines the size of the opening and can be tailored to the size and/or shape of the flask. Thus the clamps described herein may be used to secure a variety of types of glassware.

FIG. 8 illustrates another embodiment of the invention comprising axially offset sockets in parallel axial proximity. The clamp 400 comprises a base 410 comprising socket pairs 412 evenly spaced around the periphery of the base 410 is depicted The socket pair 412 comprises a first socket 414 and a second socket 415 configured to receive the first end and the second end of the wire form loop 420, respectively. The first socket 414 and second socket 415 are axially offset. When the loops ends are positioned within the sockets 414 and 415, the axially-parallel sockets and conformation of the loop 420 will load the loop, causing the loop to spontaneously coalesce. When all of the loops 420 are so attached in an interlaced over-under arrangement, the loops 420 will spontaneously coalesce and the catch 328 of one loop 320 will engage a different loop, forming an opening for receiving a flask.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A flask clamp comprising:
(a) a base and
(b) a multiplicity of interlaced loops, each of the multiplicity of interlaced loops comprising a first end, a second end, and a curved member between the first end and the second end,
wherein each of the multiplicity of interlaced loops are pivotally connected by the first end and the second end to the base; wherein the each of the curved members are configured to spontaneously coalesce; and wherein the multiplicity of interlaced loops are configured for concerted movement when an effective opening force is applied to any curved member.

2. The clamp of claim 1, wherein each of the multiplicity of interlaced loops further comprise a catch; wherein each of the multiplicity of interlaced loops further comprise a coil loop; or wherein each of the multiplicity of interlaced loops further comprise a catch and a coil loop.

3. The clamp of claim 2, wherein each of the multiplicity of interlaced loops comprise the catch.

4. The claim of claim 3, wherein the catch comprises a sigmoidal turn in the curved member

5. The clamp of claim 2, wherein each of the multiplicity of interlaced loops comprise the coil loop.

6. The clamp of claim 2, wherein each of the multiplicity of interlaced loops comprise the catch and the coil loop.

7. The claim of claim 6, wherein the catch comprises a sigmoidal turn in the curved member

8. The clamp of claim 1, wherein the base comprises a multiplicity of socket pairs comprising a first socket and a second socket arranged along the periphery of the base, wherein the multiplicity of socket pairs is equal to the multiplicity of interlaced loops, and wherein the first socket and the second socket of a single socket pair are configured to receive the first end and the second end of a single interlaced loop.

9. The clamp of claim 1, wherein the base comprises a multiplicity of socket pairs comprising a first socket and a second socket axially offset from one another and arranged along the periphery of the base, wherein the multiplicity of socket pairs is equal to the multiplicity of interlaced loops, and wherein the first socket and the second socket of a single socket pair are configured to receive the first end and the second end of a single interlaced loop.

10. The clamp of claim 1, wherein the multiplicity of interlaced loops are pivotally connected to the base via a multiplicity of torsion spring pairs comprising a first torsion spring formed from or connected to the first end of a single interlaced loop and a second torsion spring formed from or connected to the second end of the single interlaced loop, and wherein the multiplicity of torsion spring pairs is equal to the multiplicity of interlaced loops.

11. The clamp of claim 1, wherein the multiplicity of interlaced loops are equally spaced around the periphery of the base.

12. The clamp of claim 1, wherein the clamp comprises two, three, or four interlaced loops.

13. The clamp of claim 1, wherein clamp is configured to receive an Erlenmeyer flask, a Florence flask, a round-bottom flask, or a cylindrical beaker.

14. The clamp of claim 1, wherein the clamp further comprises one or more magnets attached to the base and extending downwardly from the base.

15. (canceled)

16. (canceled)

17. (canceled)

18. The clamp of claim 1, wherein the clamp further comprises at least one positioning boss extending downward from the base or wherein the clamp further comprises at least one threaded fastener extending downward from the base.

19. (canceled)

20. The clamp of claim 1, wherein the clamp base further comprises a soft elastomeric cover.

21. (canceled)

22. The clamp of claim 1, wherein the base further comprises a frictional surface on the base which engages the bottom of a flask.

23. The clamp of claim 1, wherein each of the multiplicity of interlaced loops further comprise a roller mechanism mounted on each curved member.

24. The clamp of claim 23, wherein the roller mechanisms comprise contoured plastic rollers.

25. The clamp of claim 23, wherein the roller mechanisms comprise soft elastomeric roller covers.
